(19) United States
(12) Patent Application Publication
(10) Pub. No.: US 2017/0206588 A1
(43) Pub. Date: Jul. 20, 2017

(54) SYSTEM AND METHOD FOR MONITORING, CATALOGING AND DISPLAYING POINT OF SALE TRANSACTIONS AND INFORMATION RELATED THERETO

(71) Applicant: PETROSOFT, LLC, Pittsburgh, PA (US)

(72) Inventor: SERGEI GORLOV, VENETIA, PA (US)

(73) Assignee: PETROSOFT, LLC, Pittsburgh, PA (US)

(21) Appl. No.: 15/383,870

(22) Filed: Dec. 19, 2016

Related U.S. Application Data
(60) Provisional application No. 62/268,853, filed on Dec. 17, 2015.

(51) Int. Cl. G06Q 30/06

(52) U.S. Cl. CPC G06Q 30/0633

(57) ABSTRACT

A method of monitoring and cataloging point of sale transactions includes receiving information regarding a plurality of transactions from a point of sale device. The method also includes receiving video information regarding the plurality of transactions from a number of video cameras. The video information is correlated with the information received from the point of sale device. The correlated information is then displayed. The displayed correlated information includes at least a portion of the video information for a particular transaction of the plurality of transactions along with the information received from the point of sale device for the particular transaction on a display.

### CROSS-REFERENCE TO RELATED APPLICATIONS

This patent application claims the priority benefit under 35 U.S.C. §119(e) of U.S. Provisional Application No. 62/268,853, filed on Dec. 17, 2015, the contents of which are herein incorporated by reference.

### BACKGROUND OF THE INVENTION

1. Field of the Invention

The present invention pertains to systems and methods for use in monitoring and cataloging point of sale transactions and information related thereto. The present invention also pertains to systems and methods for organizing and reviewing such transactions and information related thereto.

2. Description of the Related Art

Point of sale transactions occur in places of businesses throughout the world. In the past, records of such transactions were recorded on physical elements typically in the form of receipts generated by hand or via a cash register. With the advent of computers and computerized registers, electronic versions of such records have generally replaced such physical elements. While such electronic records are generally easier to review and potentially analyze than the receipts of the past, there is still room for improvement in the manner and type of data that is recorded/archived in connection with such transactions. There is also room for improvement in systems and methods for recording, cataloging and analyzing such transactions.

Embodiments of the present invention improve upon conventional systems and methods by providing systems and methods for gathering and analyzing information beyond the capabilities of current systems and methods.

### SUMMARY OF THE INVENTION

In one embodiment, a method of monitoring and cataloging point of sale transactions is provided. The method comprises: receiving information regarding a plurality of transactions from a POS device; receiving video information regarding the plurality of transactions from a number of video cameras; correlating the video information with the information received from the POS device; and displaying at least a portion of the video information for a particular transaction of the plurality of transactions along with the information received from the POS device for the particular transaction on a display.

Displaying at least a portion of the video information may comprise displaying a frame of the video information.

Displaying at least a portion of the video information may comprise displaying the video information as a video.

Receiving video information regarding the plurality of transactions from a number of video cameras may comprise receiving video information from a plurality of video cameras.

Displaying at least a portion of the video information may comprise simultaneously displaying a frame of the video information from at least two video cameras of the plurality of video cameras.

Displaying at least a portion of the video information may comprise displaying the video information from at least one video camera of the plurality of video cameras as a video while also displaying a frame of the video information from at least another video camera of the plurality of video cameras.

Displaying at least a portion of the video information may comprise displaying the video information from a first video camera of the plurality of video cameras as a first video while also displaying the video information from at least another video camera of the plurality of video cameras as a second video.

Displaying information received from the POS device for the particular transaction may comprise displaying one or more of: the date and time of the particular transaction, the items involved in the particular transaction, the total of the particular transaction, and the method of payment for the particular transaction.

Displaying at least a portion of the video information for a particular transaction of the plurality of transactions along with the information received from the POS device for the particular transaction on a display may further comprise displaying information received from the POS device for at least another transaction of the plurality of transactions.

In another embodiment, a system for monitoring and cataloging point of sale transactions is provided. The system comprises: a POS device; a processing device in communication with the POS device, the processing device having a memory associated therewith; a number of video cameras in communication with the processing device; and a display in communication with the processing device. The processing device is programmed to: receive information regarding a plurality of transactions from the POS device; receive video information regarding the plurality of transactions from the number of video cameras; correlate the video information with the information received from the POS device; and display, as a first view, at least a portion of the video information for a particular transaction of the plurality of transactions along with the information received from the POS device for the particular transaction on the display.

The portion of the video information may comprise a frame of the video information.

The portion of the video information may comprise a video.

The number of video cameras may comprise a plurality of video cameras.

The portion of the video information may comprise a frame of the video information from at least two video cameras of the plurality of video cameras.

The portion of the video information may comprise a video of the video information from at least one video camera of the plurality of video cameras and a frame of the video information from at least another video camera of the plurality of video cameras.

The portion of the video information may comprise a first video of the video information from at least one video camera of the plurality of video and a second video the video information from at least another video camera of the plurality of video cameras.

The information received from the POS device for the particular transaction may comprise one or more of: the date and time of the particular transaction, the items involved in the particular transaction, the total of the particular transaction, and the method of payment for the particular transaction.

The first view may further include information received from the POS device for at least another transaction of the plurality of transactions.

In another embodiment, a computer program product including a non-transitory computer readable medium encoded with a computer program is provided. The computer program comprises code for: receiving information regarding a plurality of transactions from a POS device; receiving video information regarding the plurality of transactions from a number of video cameras; correlating the video information with the information received from the POS device; storing the correlated video information and information received from the POS device as correlated information; and providing the correlated information when requested.

These and other objects, features, and characteristics of the present invention, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention.

### BRIEF DESCRIPTION OF THE DRAWINGS

FIG. 1 is a schematic overview of a system in accordance with an example embodiment of the invention; and

FIG. 2 is a display output in accordance with an example embodiment of the invention.

### DETAILED DESCRIPTION OF EXEMPLARY EMBODIMENTS

As used herein, the singular form of “a”, “an”, and “the” include plural references unless the context clearly dictates otherwise. As used herein, the statement that two or more parts or components are “coupled” shall mean that the parts are joined or operate together either directly or indirectly, i.e., through one or more intermediate parts or components, so long as a link occurs.

As employed herein, the term “number” shall mean one or an integer greater than one (i.e., a plurality).

As used herein, the terms “component” and “system” are intended to refer to a computer related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a server and the server can be a component. One or more components can reside within a process and/or thread of execution, and a component can be localized on one computer and/or distributed between two or more computers. While certain ways of displaying information to users are shown and described with respect to certain figures or graphs as screenshots, those skilled in the relevant art will recognize that various other alternatives can be employed. The terms “screen,” “web page,” and “page” are generally used interchangeably herein. The pages or screens are stored and/or transmitted as display descriptions, as graphical user interfaces, or by other methods of depicting information on a screen (whether personal computer, PDA, mobile telephone, or other suitable device, for example) where the layout and information or content to be displayed on the page is stored in memory, database, or another storage facility.

As used herein, the term “controller” or “processing device” shall mean a programmable analog and/or digital device (including an associated memory part or portion) that can store, retrieve, execute and process data (e.g., software routines and/or information used by such routines), including, without limitation, a field programmable gate array (FPGA), a complex programmable logic device (CPLD), a programmable system on a chip (PSOC), an application specific integrated circuit (ASIC), a microprocessor, a microcontroller, a programmable logic controller, or any other suitable processing device or apparatus. The memory portion can be any one or more of a variety of types of internal and/or external storage media such as, without limitation, RAM, ROM, EPROM(s), EEPROM(s), FLASH, and the like that provide a storage register, i.e., a non-transitory machine readable medium, for data and program code storage such as in the fashion of an internal storage area of a computer, and can be volatile memory or nonvolatile memory.

As used herein, “POS” shall mean “Point of Sale”, i.e., the location wherein in sale transaction takes place.

As used herein, “POS device” shall mean a device which is used to carry out a POS transaction.

As used herein, “customer” shall mean a person or persons who are making a purchase or other transaction.

As used herein, “transaction” shall be used to refer to an interaction between a customer and an employee or an interaction directly between a customer and a POS device in which the POS device is utilized to record details (e.g., time, date, items, costs, payment received, change returned, etc.).

As used herein “PJR files” shall refer to journal files from the a POS device (i.e., transaction logs—files containing all the activity on the POS device).

As used herein, “Back-Office” shall be used to refer to back-office software which is used to carry out administrative work for a convenience store and/or gas service station.

As used herein, “network-attached storage”, also referred to as “NAS” shall be used to refer a file-level computer data storage server connected to a computer network.

As used herein, “event” or “events” shall be used to refer to any activity or activities on a POS device.

As used herein, “presets” shall refer to filters which may be applied to data.

Directional phrases used herein, such as, for example and without limitation, top, bottom, left, right, upper, lower, front, back, and derivatives thereof, relate to the orientation of the elements shown in the drawings and are not limiting upon the claims unless expressly recited therein.

The invention will now be described, for purposes of explanation, in connection with numerous specific details in order to provide a thorough understanding of the subject invention. It will be evident, however, that the invention can be practiced without these specific details without departing from the spirit and scope of this innovation.

The invention pertains to systems and methods for gathering point-of sale (hereinafter “POS”) activity information both from a cash register or other suitable device as well as from store surveillance cameras and correlating and processing the information for future by one or more access devices. The invention further pertains to systems and components for carrying out such methods.

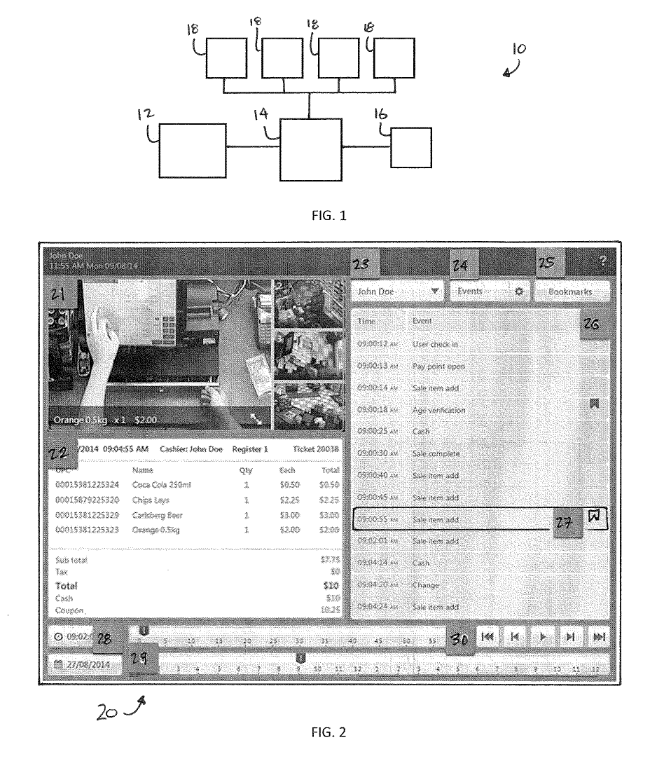

A schematic diagram showing the basic components of a system 10 in accordance with an example embodiment of the invention is shown in FIG. 1. System 10 includes a POS device 12 which includes an input/output device such as a touchscreen or other suitable device for recording information regarding transactions (e.g., without limitation, purchases, returns, exchanges). POS device 12 may include, and/or be in communication with, a processing device 14 and memory storage 16 which act to process and store information related to transactions carried out using POS device 12. Such information may include, for example, without limitation, an identifier of the particular POS device involved, an identifier of a cashier or cashiers involved, time and date of the transaction, items involved in the transaction and details (e.g., cost, quantity, size, etc.) of such items, total amount of the transaction, amount of taxes associated with the transaction, payment method received, etc. Although described as a touchscreen device herein, it is to be appreciated that POS device 12 may be of any suitable arrangement which is capable of storing (in a suitable memory) information (such as previously discussed) related to transactions carried out thereon which may then be retrieved and manipulated by a suitable processing device.

Continuing to refer to FIG. 1, system 10 further includes a number of video cameras 18 which are structured to capture video information (i.e., video footage and/or frames of video footage) of a transaction being carried out on POS device 12. In an example embodiment of the invention, store security cameras have been employed. In other example embodiments, dedicated surveillance cameras have been employed in addition to or in place of store security cameras. Each video camera 18 is in in communication with processing device 14, either directly or indirectly via any suitable wired or wireless means. In the example embodiment of FIG. 1, four video cameras 18 are shown, however, it is to be appreciated that such quantity is shown for example purposes only and that other quantities, from a single camera to generally any quantity more than one, may be employed without varying from the scope of the invention. Processing device 14 is structured to receive, process and store (using memory 16 or any other suitable memory) video information related to transactions carried out on POS device 12 received from to each video camera 18. Processing device 14 is further structured to correlate the information related to transactions carried out using POS device 12 with the corresponding video information received from each video camera 18 and store such correlated information in memory 16 (or in any other suitable memory, either local or located elsewhere).

The correlated information stored by processing device 14 may be selectively recalled, for example, without limitation, by a store clerk, manager, or other authorized user (hereinafter a “reviewer”) of system 10 for later review on POS device 12 or other suitable device located in proximity to POS device 12 or located remotely therefrom. FIG. 2, shows a view of a view 20 in accordance with an example embodiment of the invention. View 20 includes a main video display area 21 which displays video information from one or more of videos cameras 18. Each of the cameras may be selected (e.g., via touch or other suitable mechanism) in order to have the provided view enlarged, reduced, or played back. View 20 also includes a transaction details area 22 which includes details of the selected event (e.g., the date and time of the particular transaction, the items involved in the particular transaction, the total of the particular transaction, and the method of payment for the particular transaction). View 20 also includes a selectable filter by user 23 which provides for a reviewer to select among viewing activity by all users (i.e., cashiers) or just among specific users. View 20 also includes a selectable manage preset function 24 which allows for a reviewer to create a filter (e.g., without limitation, an event) or group of group of filters and save it for later usage. View 20 also includes a selectable bookmarks filter 25. By selecting the bookmarks filter 25, a reviewer can view all bookmarked transactions. Transactions may be bookmarked by the cashier by selecting the corresponding button on the main cashier's interface.

Continuing to refer to FIG. 2, view 20 further includes a journal of events 26 which includes a list of events according to the specified filtering parameters. If no parameters are specified all events are displayed. When selected, the event details and video recordings for the selected event is displayed in the main video display area 21 and transaction details area 22. An example sale event 27, which was bookmarked for some reason by the cashier, is shown selected in the journal of events 26. View 20 further includes a time filter 28 which is used to specify the time of the event(s) while a date filter is used to select the day for which activity is to be viewed. View 20 further includes timelines 29 with hours and minutes scale. The timeline markers can be moved by dragging and dropping to assist in finding events in a particular timeframe. Events are marked on the timelines with lines. View 30 further includes navigation controls 30 which may be used to play, stop, and rewind selected video recordings.

From the foregoing, it is to be appreciated that embodiments of the present invention provide improved means for accessing and reviewing transactions in a way which was previously not feasible. By correlating and integrating both numerical data and video date for transactions, large volumes of transactions can be readily sorted and quickly reviewed as desired. Such reviews may be carried out, for example without limitation, for security and/or loss prevention activities (e.g., reviewing voided transactions or “no-sales”), to ensure compliance with regulatory agencies (e.g., checking for ID for tobacco purchases), or for any other desired purpose.

Although the invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the spirit and scope of the appended claims. For example, it is to be understood that the present invention contemplates that, to the extent possible, one or more features of any embodiment can be combined with one or more features of any other embodiment.

In the claims, any reference signs placed between parentheses shall not be construed as limiting the claim. The word “comprising” or “including” does not exclude the presence of elements or steps other than those listed in a claim. In a device claim enumerating several means, several of these means may be embodied by one and the same item of hardware. The word “a” or “an” preceding an element does not exclude the presence of a plurality of such elements. In any device claim enumerating several means, several of these means may be embodied by one and the same item of hardware. The mere fact that certain elements are recited in mutually different dependent claims does not indicate that these elements cannot be used in combination.

What is claimed is:

1. A method of monitoring and cataloging point of sale transactions, the method comprising:
receiving information regarding a plurality of transactions from a POS device;
receiving video information regarding the plurality of transactions from a number of video cameras;
correlating the video information with the information received from the POS device; and
displaying at least a portion of the video information for a particular transaction of the plurality of transactions along with the information received from the POS device for the particular transaction on a display.

2. The method of claim 1, wherein displaying at least a portion of the video information comprises displaying a frame of the video information.

3. The method of claim 1, wherein displaying at least a portion of the video information comprises displaying the video information as a video.

4. The method of claim 1, wherein receiving video information regarding the plurality of transactions from a number of video cameras comprises receiving video information from a plurality of video cameras.

5. The method of claim 4, wherein displaying at least a portion of the video information comprises simultaneously displaying a frame of the video information from at least two video cameras of the plurality of video cameras.

6. The method of claim 4, wherein displaying at least a portion of the video information comprises displaying the video information from at least one video camera of the plurality of video cameras as a video while also displaying a frame of the video information from at least another video camera of the plurality of video cameras.

7. The method of claim 4, wherein displaying at least a portion of the video information comprises displaying the video information from a first video camera of the plurality of video cameras as a first video while also displaying the video information from at least another video camera of the plurality of video cameras as a second video.

8. The method of claim 1, wherein displaying information received from the POS device for the particular transaction comprises displaying one or more of: the date and time of the particular transaction, the items involved in the particular transaction, the total of the particular transaction, and the method of payment for the particular transaction.

9. The method of claim 1, wherein displaying at least a portion of the video information for a particular transaction of the plurality of transactions along with the information received from the POS device for the particular transaction on a display further comprises displaying information received from the POS device for at least another transaction of the plurality of transactions.

10. A system for monitoring and cataloging point of sale transactions, the system comprising:
a POS device;
a processing device in communication with the POS device, the processing device having a memory associated therewith;
a number of video cameras in communication with the processing device; and
a display in communication with the processing device,
wherein the processing device is programmed to:
receive information regarding a plurality of transactions from the POS device;
receive video information regarding the plurality of transactions from the number of video cameras;
correlate the video information with the information received from the POS device; and
display, as a first view, at least a portion of the video information for a particular transaction of the plurality of transactions along with the information received from the POS device for the particular transaction on the display.

11. The system of claim 10, wherein the portion of the video information comprises a frame of the video information.

12. The system of claim 10, wherein the portion of the video information comprises a video.

13. The system of claim 10, wherein the number of video cameras comprises a plurality of video cameras.

14. The system of claim 13, wherein the portion of the video information comprises a frame of the video information from at least two video cameras of the plurality of video cameras.

15. The system of claim 13, wherein the portion of the video information comprises a video of the video information from at least one video camera of the plurality of video cameras and a frame of the video information from at least another video camera of the plurality of video cameras.

16. The system of claim 13, wherein the portion of the video information comprises a first video of the video information from at least one video camera of the plurality of video and a second video the video information from at least another video camera of the plurality of video cameras.

17. The system of claim 10, wherein the information received from the POS device for the particular transaction comprises one or more of: the date and time of the particular transaction, the items involved in the particular transaction, the total of the particular transaction, and the method of payment for the particular transaction.

18. The system of claim 10, wherein the first view further includes information received from the POS device for at least another transaction of the plurality of transactions.

19. A computer program product including a non-transitory computer readable medium encoded with a computer program comprising program code for:
receiving information regarding a plurality of transactions from a POS device;
receiving video information regarding the plurality of transactions from a number of video cameras;
correlating the video information with the information received from the POS device;
storing the correlated video information and information received from the POS device as correlated information; and
providing the correlated information when requested.
